(19) United States
(12) Patent Application Publication
(10) Pub. No.: US 2006/0061997 A1
(43) Pub. Date: Mar. 23, 2006

(54) Serviceable, exchangeable LED assembly

(75) Inventor: Zhaohui Lin, Salt Lake City, UT (US)

Correspondence Address: Parsons Behle & Latimer;Suite 1800, 201 South Main Street, P. O. Box 45898, Salt Lake City, UT, 84111, US

(73) Assignee: Cao Group, Inc.

(21) Appl. No.: 11/231,325

(22) Filed: Sep. 20, 2005

Related U.S. Application Data
(60) Provisional application No. 60/611,494, filed on Sep. 20, 2004.

(51) Int. Cl. F21V 29/00

(52) U.S. Cl. 362/294

(57) ABSTRACT

Structures and methodologies are disclosed for attaching an LED to a heat sink to permit the LED to be removable and replaceable, thereby making a serviceable LED assembly with an exchangeable LED.

### PRIORITY

Priority is hereby claimed under 35 U.S.C. 119 to U.S. Provisional Patent Application Ser. No. 60/611,494 filed on Sep. 20, 2004.

### BACKGROUND

LED's (light emitting diodes) which emit multiple wavelengths or colors of light and which have a power level greater than about 50 milliwatts will be useful in many future applications, such as lighting, instrumentation, signage, traffic signals, medicine, and other fields. One issue with high power LEDs is heat generation. In order to manage heat, a head sink or other heat dissipation technique, such as a fan or water flow, can be used. A common way to attach an LED to a heat sink is via heat conductive adhesive, but if the LED stops working, then the entire component must be discarded, making parts replacement costly. Such LEDs are not exchangeable or serviceable but are disposable instead.

### BRIEF DESCRIPTION OF THE DRAWINGS

FIG. 1a depicts a perspective view of an LED assembly.

FIG. 1b depicts a side view of the LED assembly of FIG. 1a.

FIG. 2a depicts a perspective view of another LED assembly.

FIG. 2b depicts a perspective view of the LED assembly of FIG. 2a.

### DETAILED DESCRIPTION

Structures and methodologies are disclosed for attaching an LED to a heat sink to permit the LED to be removable and replaceable, thereby making a serviceable LED assembly with an exchangeable LED.

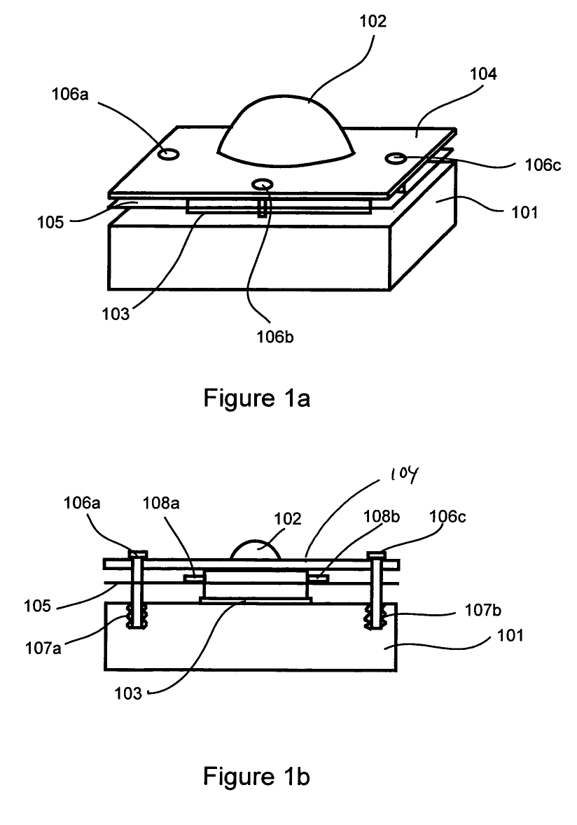

Referring to FIG. 1a, a perspective view of a serviceable LED assembly with exchangeable LED is provided. A heat sink 101 is provided to draw heat away from LED 102. Heat conduction paste 103 optionally lies between the LED 102 and the heat sink 101 to transfer heat from the LED to the heat sink. A clamping mechanism 104, such as a thin metal plate or other appropriate clamping structure, is provided to hold a PCB board 105 on which the LED is mounted against the heat sink and heat paste. An aperture may be provided in the clamping mechanism 104 through which the LED 102 may shine light in a useful direction. Fasteners, such as screws, bolts, rivets, pins or other fasteners 106a, 106b and 106c may be used to hold the plate, PCB board and heat sink together as a unit via mechanical force. If the LED stops functioning, the fasteners may be removed, along with the clamping mechanism, and the LED may be conveniently exchanged or replaced.

Referring to FIG. 1b, a cross section of the device of FIG. 1a is depicted. Connection 108 provides electrical connection between the LED and the PCB. Screw or bolt sockets 107a and 107b receive the screws or bolts that hold the assembly together.

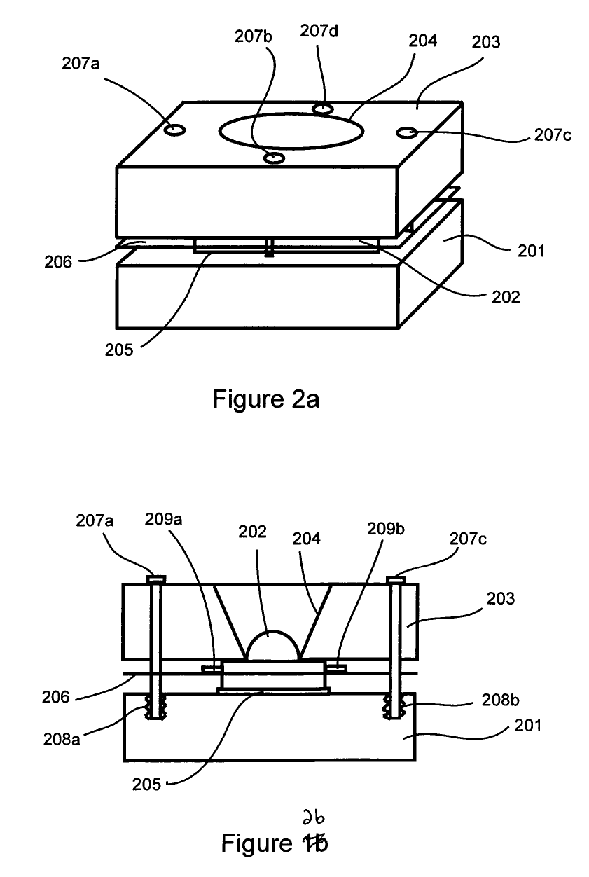

Referring to FIG. 2a, a similar device is depicted with an optical beam shaping feature in the clamping mechanism. FIG. 2b is a cross section of FIG. 2a. Depicted are a heat sink 201, an LED 202, clamping mechanism 203 with optical reflector 204 in it. Optionally the optical reflector or beam shaper could be separately configured and attached. Heat conduction paste 205 is provided between the LED and the heat sink. A PCB board 206 holds the LED, and electrical connectors 209a and 209b are provided between the LED and the PCB. Screws 207a and 207b hold the assembly together by projecting into screw receiving holes 208a and 209b.

While devices and methods have been described and illustrated in conjunction with a number of specific configurations, those skilled in the art will appreciate that variations and modifications may be made without departing from the principles herein illustrated, described, and claimed. The present invention, as defined by the appended claims, may be embodied in other specific forms without departing from its spirit or essential characteristics. The configurations described herein are to be considered in all respects as only illustrative, and not restrictive. All changes which come within the meaning and range of equivalency of the claims are to be embraced within their scope.

1. A serviceable LED unit comprising:
a heat sink,
heat conduction paste on at least a portion of the surface area of said heat sink,
an LED in contact with said heat conduction paste so that heat generated by said LED can be transported through said paste into said heat sink,
a PCB board on which said LED is mounted,
at least one fastener, said fastener being removable,
a clamping assembly which affixes said PCB with respect to said heat sink by use of said fastener,
said clamping assembly being removable by removing said fastener, thus permitting access to said PCB so that said LED may be removed and exchanged in order to service the unit.

2. A device as recited in claim 1 further comprising an aperture in said clamping mechanism for permitting light from said LED to shine therethrough.

3. A device as recited in claim 1 wherein said clamping mechanism is a metal plate.

4. A device as recited in claim 1 wherein said LED emits a plurality of wavelengths of light.

5. A device as recited in claim 1 wherein said fasteners are selected from the group consisting of screws, bolts, rivets and pins.

6. A device as recited in claim 2 further comprising an optical reflector at said aperture.

7. A device as recited in claim 2 further comprising a beam shaping device at said aperture.

8. A device as recited in claim 1 wherein said clamping mechanism has an integral optical reflector of beam shaping mechanism built into it at said aperture.
